(19) United States
(12) Patent Application Publication
(10) Pub. No.: US 2006/0208021 A1
(43) Pub. Date: Sep. 21, 2006

(54) Kayak carrying and locking system

(76) Inventors: Jeremy Ryan Himle, Meridian, ID (US); Michael Shane Preston, Boise, ID (US)

Correspondence Address: David Zwick, 7538 W. Kimberly Way, Glendale, AZ, 85308, US

(21) Appl. No.: 11/083,496

(22) Filed: Mar. 18, 2005

(51) Int. Cl. B60R 9/048

(52) U.S. Cl. 224/324; 224/331

(57) ABSTRACT

A kayak carrying and locking system that attaches to a roof rack, having a prong bracket fixed at one end of a long rod, a sliding prong-bracket able to travel along the rod, the brackets having prongs that point upward and outward at opposing acute angles. The sliding prong-bracket includes a locking arrangement to lock it in place on the rod. A kayak is placed cockpit down such that the prongs of the fixed prong-bracket hook the lip of the cockpit opening, the sliding prong-bracket is positioned to securely hook its prongs on the opposite lip of the cockpit opening, and the sliding prong-bracket is locked into place.

### FIELD OF THE INVENTION

The present invention relates to a system for carrying and securing a kayak to a vehicle roof rack.

### BACKGROUND OF THE INVENTION

Enthusiasts of kayaking recognize the need to be able to carry and secure a kayak to a vehicle roof rack. A common type of prior art system, as exemplified by U.S. Pat. No. 6,199,412 by Kennedy is a locking tie-down. The kayak is mounted on the car rack cross-members and a pair of locking tie-downs hold and secure the kayak to the front and rear roof rack cross-members. The tie-downs, typically made from nylon webbing, are positioned forward and rearward of the kayak's wider middle section such that the kayak cannot be slid outward through either tie-down.

While this type of carrying and securing system does hold the kayak in place, a problem with this type of system is that a determined thief can relatively easily cut the webbing and abscond with the kayak.

### SUMMARY OF THE INVENTION

Accordingly, it is an object of the present invention to provide a system to carry a kayak on a vehicle roof rack.

Another object of the present invention is to secure the kayak to the roof rack so as to deter would-be thieves.

A preferred embodiment of the present invention is a system having a prong bracket fixed at one end of a long square rod, and a sliding prong-bracket able to travel along the rod. The sliding prong-bracket includes a rod engagement and locking arrangement to engage slots on the rod and to lock this bracket in place on the rod. The prongs of the two prong-brackets point upward and outward at opposing acute angles. The fixed prong-bracket has attachment brackets to allow secure attachment to a roof rack-cross member, and a second attachment bracket secures the square rod to a second roof rack cross-member.

In operation, the carrying system is secured to roof rack cross-members via the attachment brackets. A kayak is placed longitudinally onto the roof rack, cockpit down such that the prongs of the fixed prong-bracket hook the lip of the cockpit opening. The sliding prong-bracket is positioned to securely hook its prongs on the opposite lip of the cockpit opening. The sliding prong-bracket is then locked in place.

Positioned thus, the kayak is securely attached to the carrying system via the prong brackets, and the system is securely attached to the vehicle roof rack. The carrying system is made of a sufficiently heavy gage of material to make it very difficult to detach the kayak from the carrying system.

### DESCRIPTION OF THE DRAWINGS

FIG. 1 shows a diagram of a fixed prong-bracket end of a preferred embodiment of the present invention.

FIG. 2 shows a diagram of a sliding prong-bracket and notched end of the square rod of a preferred embodiment of the present invention.

FIG. 3 shows a diagram of a securing bracket of a preferred embodiment of the present invention.

### DESCRIPTION OF A PREFERRED EMBODIMENT

A preferred embodiment of the present invention is described in the context of a vehicle roof mounted recreational equipment carrying rack with lateral cross-members. Such racks are commercially available from companies such as Yakima Products, Inc. and Thule, Inc.

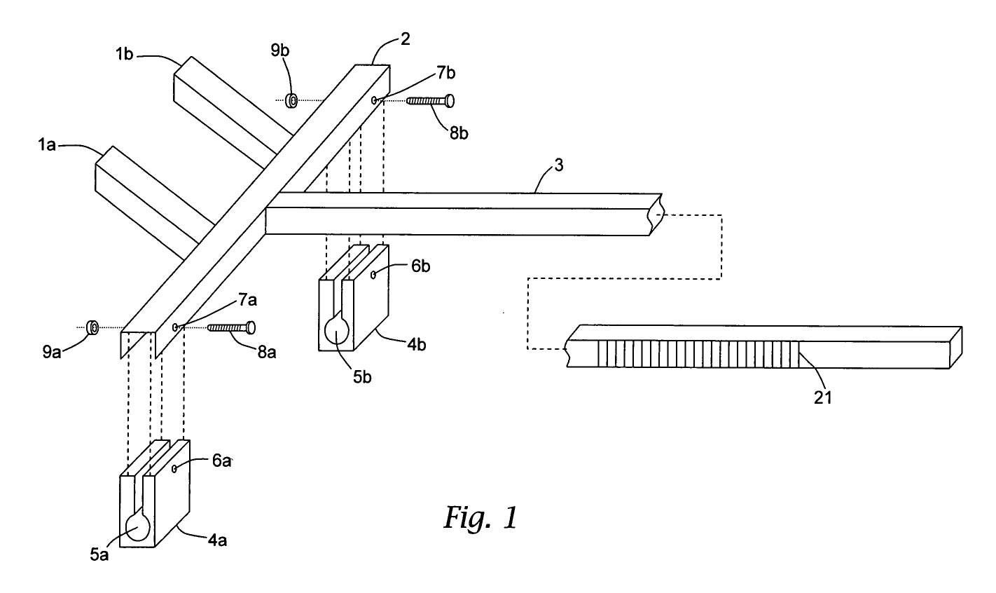

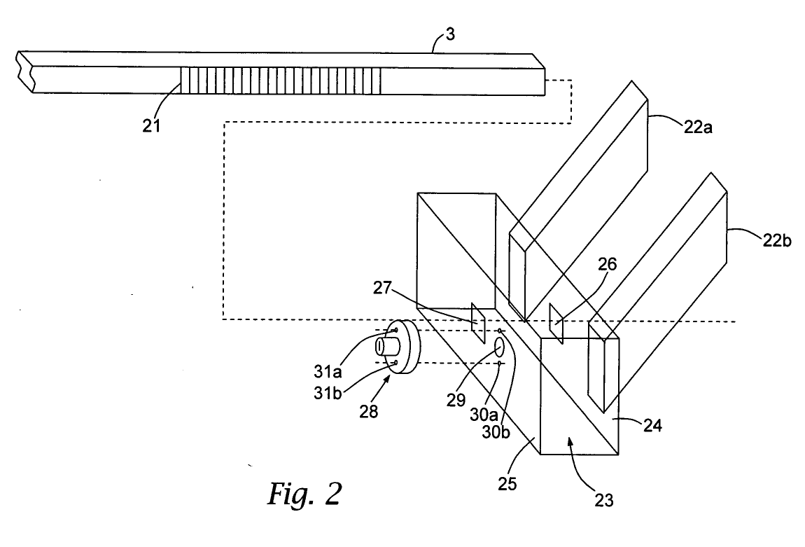

FIG. 1 shows a block diagram of the fixed prong-bracket end of a preferred embodiment of the present invention and FIG. 2 shows a see-through diagram of the sliding prong-bracket of a preferred embodiment of the present invention.

Prongs 1a and 1b are attached by any suitable means to a U-channel cross-member 2, together forming a fixed prong-bracket. A square rod 3 is also attached to U-channel cross-member 2. A series of notches 21 are cut into a side face of square rod 3 near its free end. Equipment rack cross-member securing brackets 4a and 4b attach to U-channel cross-member 2 via screws and nuts 8a/8b and 9a/9a and through-holes 6a/6b and 7a/7b.

Prongs 22a and 22b are attached by any suitable means to the outward face 24 of sliding prong-bracket box 23. Opposing holes 26 and 27 are cut into the outward face 24 and inward face 25, respectively, of sliding prong-bracket box 23. Prongs 22a and 22b, sliding prong-bracket box 23, and opposing holes 26 and 27 form a sliding prong-bracket. Opposing holes 26 and 27 are dimensioned closely to square rod 3 and arranged so as to allow square rod 3 to extend through holes 26 and 27, and allow sliding prong-bracket box 23 to slide along the length of square rod 3.

A rod engaging and locking arrangement 28 is attached to the inside surface of inward face 25 via screws (not shown) that would be secured via through-holes 30a/30b and 31a/31b. In this embodiment, rod engaging and locking arrangement 28 has a tumbler column that would extend through inward face 25 via hole 29. A key would be inserted into the tumbler column and, upon turning, would cause a lock tang (on the hidden side of locking arrangement 28 in FIG. 2) to be extended laterally from the body of rod engaging and locking arrangement 28. Rod engaging and locking arrangement 28 is positioned such that, when secured to inward face 25, the lock tang will extend into hole 27.

In this preferred embodiment, a rod engagement arrangement comprising the lock tang, and a locking arrangement comprising the tumbler column in concert with the lock tang, are integrated. More generally, these arrangements can be discrete.

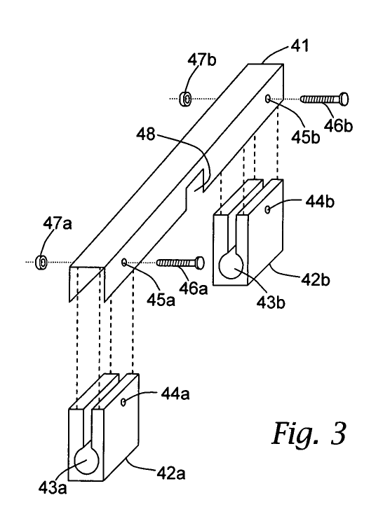

FIG. 3 shows a diagram of a square-rod securing bracket of a preferred embodiment of the present invention. Equipment rack cross-member securing brackets 42a and 42b attach to U-channel cross-member 41 via screws and nuts 46a/46b and 47a/47a and screw through-holes 44a/44b and 45a/45b. U-channel cross-member 41 has a cutout 48 dimensioned so as to fit closely to square rod 3.

When properly oriented, prongs 1a, 1b, 22a, and 22b extend upward from the roof mounted recreational equipment rack, with prongs 1a/1b pointing outward at opposing acute angles to prongs 22a/22b.

In operation, equipment rack cross-member securing brackets 4a and 4b are fitted around a first roof mounted recreational equipment rack cross-member, with the recreational equipment rack cross-member extending through holes 5a and 5b. Equipment rack cross-member securing brackets 4a and 4b are then secured to U-channel cross-member 2 with screws and nuts 8a/8b and 9a/9b. This arrangement securely holds the fixed prong-bracket in place.

The sliding prong-bracket is then slid onto square rod 3 via through-holes 26 and 27 to a relatively inward position towards the fixed prong-bracket. The sliding prong-bracket is oriented such that prongs 22a and 22b are facing in the opposing direction from prongs 1a and 1b. Initially, the lock tang of rod engaging and locking arrangement 28 is in a non-extended position.

A kayak is placed cockpit down longitudinally onto the equipment roof rack and positioned such that prongs 1a and 1b of the fixed prong-bracket hook the lip of the cockpit opening.

The sliding prong-bracket, initially positioned within the kayak cockpit opening, is then slid outward towards the free end of square rod 3 so as to securely hook prongs 22a and 22b on the lip of the cockpit opening opposite the portion hooked by the fixed prong-bracket.

Rod engaging and locking arrangement 28 is then activated to extend its lock tang into hole 27, and thus engage whichever one of notches 21 that the lock tang is aligned with.

The kayak carrying system is further secured to the recreational equipment roof rack system with the securing bracket shown in FIG. 3. Equipment rack cross-member securing brackets 42a and 42b are fitted around a second roof mounted recreational equipment rack cross-member, with the recreational equipment rack cross-member extending through holes 43a and 43b. Square rod 3 is then positioned in cutout 48. Equipment rack cross-member securing brackets 42a and 42b are then secured to U-channel cross-member 41 with screws and nuts 46a/46b and 47a/47b. This arrangement clamps square rod 3 between U-channel cross-member 41 and the second roof mounted recreational equipment rack cross-member. The second roof mounted recreational equipment rack cross-member and the securing bracket are positioned along square rod 3 so as not to interfere with the securing and locking functions of the sliding prong-bracket, and to typically provide carrying support for the kayak.

Arranged thus, the kayak is securely attached to the kayak carrying system, and the carrying system is securely attached to the recreational equipment roof rack.

### ALTERNATIVE PREFERRED EMBODIMENTS

While a preferred embodiment of the present invention has been described above, alternative embodiments may be employed without departing from the scope and spirit of the invention.

While the preferred embodiment includes pairs of prongs 1a/1b and 22a/22b attached to prong brackets to engage the cockpit lip, other cockpit engagement members attached to engagement brackets may be used. Other suitable cockpit engagement members include, but are not limited to, U-shaped engagement members attached to engagement brackets such that the closed end of each U engages the cockpit lip. Solid unitary engagement members may also be used. The engagement members must securely hook the lip of the cockpit opening.

While a specific rod engaging and locking arrangement is shown and described above, it will be understood that any of a large number of suitable rod engaging and locking arrangements may be used. In the preferred embodiment described above, the rod engaging arrangement is integrated with the locking arrangement. Generally, these arrangements may be discrete.

The rod engaging arrangement, when engaged, must keep the sliding prong-bracket from sliding inward along the rod and may, optionally, hold the sliding prong-bracket in place. Suitable rod engaging arrangements include, but are not limited to, pawl arrangements that engage a saw-tooth pattern cut into the rod, a simple hole through the rod for a lock pin, and friction arrangements.

The locking arrangement securely limits the inward travel of the sliding prong-bracket so as not to allow enough travel such that the kayak can be removed from the system. Suitable arrangements include, but are not limited to, spaced holes through the rod allowing a pad lock to be locked to the rod via the holes, or a pad lock attached via a through hole to the lock pin described just above.

While the preferred embodiment includes a square rod, other shapes may be used as long as they are compatible with the locking arrangement. While the square rod assists in keeping the sliding prong-bracket rotationally oriented about the square rod, other shapes such as ovals, polygons and circles may be used.

While the preferred embodiment describes a system for attaching the kayak carrying system to a roof rack, any suitable attachment means that is compatible with the particular roof rack and the kayak carrying system may be used. For example, each roof rack manufacturer typically has an assortment of general attachment brackets.

It is intended that the scope of the invention be defined by the claims appended hereto and their equivalents.

What is claimed is:

1. A kayak carrying and securing system, a kayak having a cockpit opening defined by a lip, comprising:
a rod;
a fixed engagement bracket attached to an end of said rod and including one or more engagement members;
a sliding engagement bracket disposed about said rod and arranged to slide along said rod and including one or more engagement members;
a rod engaging arrangement to at least stop movement of said sliding engagement bracket towards said end; and
attachment brackets to securely attach said kayak carrying system to a vehicle roof rack;
said fixed engagement bracket engagement members and said sliding engagement bracket engagement members pointing upward and outward;
said fixed engagement bracket engagement members operated to hook the lip of the kayak cockpit opening, said sliding engagement bracket operated to be positioned along said rod such that said sliding engagement bracket engagement members hook the opposite side of the lip, said rod engaging arrangement operated to hold said sliding engagement bracket engagement members in position hooked to the kayak lip.

2. A kayak carrying and securing system according to claim 1, further comprising a locking arrangement to securely stop said sliding engagement bracket from sliding inward along said rod sufficient to remove the kayak from the system.

3. A kayak carrying and securing system according to claim 1, wherein said engagement members comprise prongs.

4. A kayak carrying and securing system according to claim 1, wherein said fixed engagement bracket and sliding engagement bracket engagement members each comprise a U-shaped member attached to said engagement brackets such that the closed end of each U engages the cockpit lip.

5. A kayak carrying and securing system according to claim 1, wherein said fixed engagement bracket and sliding engagement bracket engagement members each comprise a solid unitary member.

6. A kayak carrying and securing system according to claim 1, wherein said locking arrangement comprises a lock tang that engages slots cut into said rod.

7. A kayak carrying and securing system according to claim 1, wherein said locking arrangement comprises a pawl that engages a saw-tooth pattern cut into said rod.

8. A kayak carrying and securing system according to claim 1, wherein said locking arrangement comprises a lock pin that is disposed into holes drilled through said rod.

9. A kayak carrying and securing system according to claim 1, wherein said locking arrangement is integral with said sliding engagement bracket.

10. A kayak carrying and securing system according to claim 1, wherein said locking arrangement is separate from said sliding engagement bracket.
